(19) United States
(12) Patent Application Publication
(10) Pub. No.: US 2010/0120965 A1
(43) Pub. Date: May 13, 2010

(54) Optical Organic-Inorganic Composite Material and Optical Element

(76) Inventors: Masako Kikuchi, Tokyo (JP); Hiroto Itoh, Tokyo (JP); Akiyoshi Kimura, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/532,988

(22) PCT Filed: Mar. 11, 2008
(86) PCT No.: PCT/JP2008/054373

§ 371 Date: Sep. 24, 2009

(30) Foreign Application Priority Data
Mar. 28, 2007 (JP) 2007-084002

(51) Int. Cl. C08K 3/34

(52) U.S. Cl. 524/444

(57) ABSTRACT

Provided are an optical organic-inorganic composite material exhibiting excellent transparency with respect to light having a short wavelength of around 405 nm and an optical element fitted with the optical organic-inorganic composite material, and sufficiently improving temperature dependence of the optical property (refractive index) by utilizing a resin with which an optical element is prepared at low coat in comparison to a glass material. Disclosed is an optical organic-inorganic composite material comprising inorganic particles possessing a composite oxide in which at least two kinds of metal oxides are incorporated, the inorganic particles dispersed in a resin in a state of primary particles or in a state where the plural number of primary particles are coagulated, wherein the dispersed particles have a refractive index variation standard deviation σ of 0.03 or less, and the inorganic particles have an average primary particle diameter of 1-50 nm.

### TECHNICAL FIELD

The present invention relates to an organic-inorganic composite material, which is small in variation ratio of refractive index with respect to temperature and exhibits excellent transparency and which is used for a lens, a filter, a grating, an optical fiber, a flat optical waveguide or the like, and to an optical element employing the same.

### BACKGROUND

For an optical information recording medium (hereinafter, also referred to simply as a medium) such as MO, CD, DVD or the like, devices to read and record information such as a player, a recorder, a drive, and the like are provided with an optical pickup apparatus. The apparatus is equipped with an optical unit, in which a light, reflected after the optical information recording medium is exposed to light having a predetermined wavelength produced from a light source, is received with a light receiving element, and the optical element unit possesses optical elements such as a lens and so forth to condense the light on a reflective layer of the optical information recording medium and the light receiving element.

The optical element of the optical pickup apparatus is preferably a plastic as the material in that it is manufactured at low cost according to injection molding or the like.

As the plastic for the optical element, there is known a copolymer of cyclic olefin and α-olefin (refer to Patent Document 1, for example).

The optical element employing the plastic as a material is required to have an optical stability as in a glass lens. For example, a plastic material for optical use such as cyclic olefin is extremely low in water absorption rate, as compared with polymethyl methacrylate used hitherto as a plastic for a lens, and greatly improves variation of refractive index due to water absorption. However, temperature dependency of an optical property (specifically refractive index) of the plastic material for optical use still remains unsolved, and it is greater by one or more orders of magnitude than that of inorganic glass.

In order to solve the above problem of the plastic material for optical use, there is proposed a method in which fine particles are used as fillers. There is proposed an optical product as disclosed, for example in Patent Document 2, in which in order to reduce temperature dependency of refractive index |dn/dT|, particles satisfying dn/dT>0 are dispersed in a polymeric host material satisfying dn/dT<0.

Use of a large amount of inorganic particles is necessary to reduce |dn/dT| of the optical product having the foregoing dispersed particles, however, it is supposed that it causes light scattering due to the inorganic particles, resulting in lowering of light transmittance. In order to solve this problem, there is proposed a technique as disclosed in Patent Document 3, concerning an organic-inorganic composite material containing composite metal oxide nanoparticles made of Si and at least one kind of metal elements other than Si.

Further, there is proposed a technique to provide a transparent resin composition having high refractive index as disclosed in Patent Document 4, concerning a high refractive index resin composition containing transparent particles in which the refractive index increases continuously or in a stepwise fashion toward the center portion from the surface of the particle.

Patent Document 1: Japanese Patent O.P.I. Publication No. 2002-105131 (page 4)

Patent Document 2: Japanese Patent O.P.I. Publication No. 2002-207101 (SCOPE OF THE CLAIMS)

Patent Document 3: Japanese Patent O.P.I. Publication No. 2005-146042 (SCOPE OF THE CLAIMS)

Patent Document 4: Japanese Patent O.P.I. Publication No. 2006-213410 (SCOPE OF THE CLAIMS)

### DISCLOSURE OF TEE INVENTION

### Problems to be Solved by the Invention

Incidentally, as to an optical pickup apparatus, reproducing of information recorded into an optical disk, a laser light source employed as a light source to record information into an optical disk are shifted toward shorter wavelengths. For example, a laser light source at a wavelength of 405 nm such as blue-violet SHG laser and so forth to conduct a wavelength conversion of infrared semiconductor laser by utilizing blue-violet semiconductor laser or the second harmonic generation is being put into practical use.

When the blue-violet semiconductor laser is employed, and an objective lens having the same number of openings (NA) as that of DVD is used, it is possible to record information of 15-20 GB with respect to an optical disk having a diameter of 12 cm, and when increasing NA of an objective lens up to 0.85, it is further possible to record information of 23-27 GB with respect to an optical disk having a diameter of 12 cm.

In cases where a resin material in which inorganic particles disclosed in each of Patent Documents described above is applied to an optical element possessing an optical pickup apparatus fitted with a blue-violet laser light source, there is a problem such that influence of light scattering caused by inorganic particles can not be neglected in comparison to CD as well as DVD. This problem is solved by controlling a particle diameter of the inorganic particle, and minimizing the difference in refractive index between the inorganic particle and a resin. Further, to solve this problem, it is gradually to be understood that this problem is solved only when a composite oxide particle having a refractive index close to that of the resin, is employed, and interparticle variation in refractive index of the composite oxide particle is small. The transparent organic-inorganic composite material utilizing composite oxide particles is disclosed in Patent Documents 3 and 4 described above, but in the case of inorganic particles prepared by the methods described in Patent Documents 3 and 4, interparticle variation in refractive index is not sufficiently controlled, and lowering of light transmittance caused by light scattering of blue-violet laser light is not solved.

The present invention was made on the basis of the above-described situation, and it is an object of the present invention to provide an optical organic-inorganic composite material exhibiting excellent transparency with respect to light having a short wavelength of around 405 nm and an optical element fitted with the optical organic-inorganic composite material, and sufficiently improving temperature dependence of the optical property (refractive index) by utilizing a resin with which an optical element is prepared at low coat in comparison to a glass material.

### Means to Solve the Problems

The above-described object of the present invention is accomplished by the following structures.

(Structure 1) An optical organic-inorganic composite material comprising inorganic particles comprising a composite oxide in which at least two kinds of metal oxides are incorporated, the inorganic particles dispersed in a resin in a state of primary particles or in a state where the plural number of primary particles are coagulated, wherein the dispersed particles have a refractive index variation standard deviation σ of 0.03 or less, and the inorganic particles.

(Structure 2) The optical organic-inorganic composite material of Structure 1, wherein the inorganic particles comprise a composite oxide in which silica and at least one kind of metal oxide other than silicon oxide are incorporated.

(Structure 3) The optical organic-inorganic composite material of Structure 1, wherein the inorganic particles comprise a particle having a core/shell structure in which a core made of metal oxide other than silicon oxide is covered by silica, the core/shell particle obtained by coating silica onto a surface of a core particle via reaction of a silica precursor in a dispersion comprising the core particle.

(Structure 4) The optical organic-inorganic composite material of any one of Structures 1-3, wherein nₚ and nₘ satisfy all of the following Formulae (1)-(3), provided that the inorganic particles have an average refractive index of nₚ, and the resin before dispersing the inorganic particles has a refractive index of nₘ:

1.5≦nₘ≦1.7 Formula (1)

1.5≦nₚ≦1.7 Formula (2)

|nₚ−nₘ≦0.05. Formula (3)

(Structure 5) An optical element comprising the optical organic-inorganic composite material of any one of Structures 1-4 as a mold material.

### EFFECT OF THE INVENTION

In the present invention, provided can be an optical organic-inorganic composite material exhibiting excellent transparency with respect to light having a short wavelength of around 405 nm and an optical element fitted with the optical organic-inorganic composite material, and sufficiently improving temperature dependence of the optical property (refractive index) by utilizing a thermoplastic resin with which an optical element is prepared at low coat in comparison to a glass material.

### BRIEF DESCRIPTION OF THE DRAWING

FIG. 1 is a schematic diagram showing an example of a pickup apparatus for an optical disk, in which an optical organic-inorganic composite material of the present invention is used as an objective lens.

### EXPLANATION OF NUMERALS

1 Optical pickup apparatus
2 Semiconductor laser oscillator
3 Collimator
4 Beam splitter
5 ¼ wavelength plate
6 Aperture
7 Objective lens
8 Sensor lens group
9 Sensor
10 Two-dimensional actuator
D Optical disk
D1 Protective substrate
D2 Information recording plane

### DESCRIPTION OF THE PREFERRED EMBODIMENTS

Next, the preferred embodiments of the present invention will be described in detail.

After considerable effort during intensive studies, the inventors have found out that by utilizing an optical organic-inorganic composite material possessing inorganic particles made of a composite oxide in which at least two kinds of metal oxides are incorporated, the inorganic particles dispersed in a resin in a state of primary particles or in a state where the plural number of primary particles are coagulated, wherein the dispersed particles have a refractive index variation standard deviation u of 0.03 or less, and the inorganic particles have an average primary particle diameter of 1-50 nm, realized can be the optical organic-inorganic composite material exhibiting excellent transparency with respect to light having a short wavelength of around 405 nm, and sufficiently improving temperature dependence of the optical property (refractive index) by utilizing a thermoplastic resin with which an optical element is prepared at low coat in comparison to a glass material, and the present invention has been accomplished.

Next, the resin constituting the optical organic-inorganic composite material of the present invention, inorganic particles and kinds of additives, and a method of manufacturing the optical organic-inorganic composite material of the present invention and an application field thereof will be described in detail.

### <<Resin>>

Commonly available transparent resins usable for an optical material such as a thermoplastic resin, a thermosetting resin, a light curing resin and so forth can be provided as the resin applicable for the optical organic-inorganic composite material of the present invention. Among these, a resin satisfying the condition specified by the following Formula (1), is preferably usable, when refraction index of the resin is represented by nₘ, because of excellent temperature dependency in cases where the optical organic-inorganic composite material of the present invention is used as an optical element for an optical pickup apparatus.

Specifically, spherical aberration (hereinafter, referred to as “ΔSA”) generated during 30° C. rise in operating temperature of an optical pickup apparatus is provided as a temperature characteristic of an optical element, for example, but ΔSA of the optical element can be minimized by using a resin having a refractive index of at least 1.5. Further, since when the optical element is an objective lens, shape of the lens on the optical disl side becomes meniscus, the lens peripheral portion tends possibly to collide with the optical disk in the case of the optical element having a refractive index of more than 1.7, a resin used for the optical organic-inorganic composite material of the present invention preferably satisfies the condition specified by the following Formula (1).

Formula (1) 1.5≦nₘ 1.7, wherein refractive index nₘ of a resin means a refractive index measured at 23° C. employing a light source having a wavelength of 588 nm.

The refractive index nₘ of a resin can be measured with a commonly known refractometer, and examples of the refractometer include an Abbe refractometer (DR-M2, manufactured by ATAGO Co., Ltd.), an automatic refractometer (KPR-200 manufactured by Kalnew Optical Industrial Co., Ltd.) and so forth.

The thermoplastic resin and the curable resin applicable for the optical organic-inorganic composite material of the present invention will now be described below.

### [Thermoplastic Resin]

The thermoplastic resin employed in the present invention is preferably an acrylic resin, a cyclic olefin resin, a polycarbonate resin, a polyester resin, a polyether resin, a polyamide resin, or a polyimide resin in view of its processing suitability for an optical element. Of these, a cyclic olefin resin is specifically preferable. As specific examples of the cyclic olefin resin, the compounds disclosed in Japanese Patent O.P.I. Publication No. 2003-73559 can be exemplified. Preferred compounds thereof are shown below.

TABLE 1

| Compound | | Refractive | Abbe's |
|---|---|---|---|
| No. | Structure | index n | number v |
| (1) | 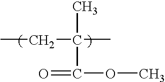 | 1.49 | 58 |
| (2) | 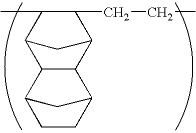 | 1.54 | 56 |
| (3) | 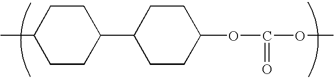 | 1.53 | 57 |
| (4) | 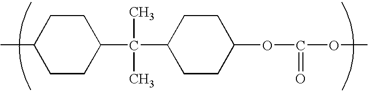 | 1.51 | 58 |
| (5) | 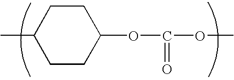 | 1.52 | 57 |
| (6) | 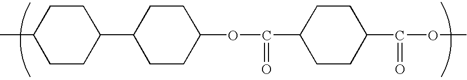 | 1.54 | 55 |
| (7) | 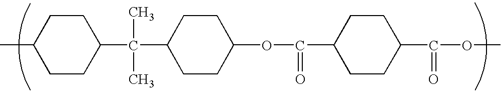 | 1.53 | 57 |
| (8) | 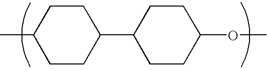 | 1.55 | 57 |
| (9) | 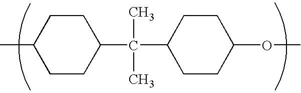 | 1.54 | 57 |
| (10) | 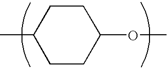 | 1.55 | 58 |
| (11) | 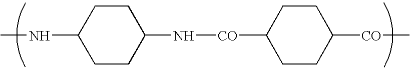 | 1.55 | 53 |
| (12) | 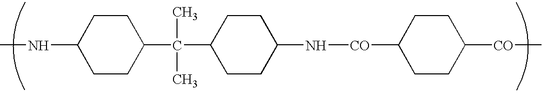 | 1.54 | 55 |
| (13) | 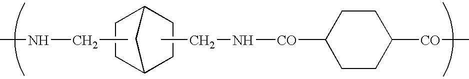 | 1.54 | 56 |
| (14) | 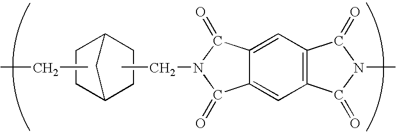 | 1.58 | 43 |

In addition, the thermoplastic resins describe above have moisture absorptivity of not more than 0.2% in view of dimensional stability for an optical material. Therefore, a polyolefin resin (polyethylene, polypropylene), a fluorine-containing resin (polytetrafluoroethylene, Teflon (registered trademark) AF (produced by Dupont), a cyclic olefin resin (ZEONEX produced by Nihon Zeon Co., Ltd., APEL produced by Mitsui Chemicals Inc., ARTON produced by JSR Co., Ltd. and TOPAS produced by Chikona Co., Ltd.), an indene/styrene based resin, a polycarbonate resin or the like is preferably utilized.

### [Curable Resin]

The curable resin employed in the present invention is a resin which is capable of being cured upon UV radiation, electron beam exposure or heat treatment, and it may be used specifically with no limitation as long as the transparent resin composition is formed via curing with the above-described process after mixing inorganic particles with an uncured curable resin. As the curable resin, preferably used are an epoxy resin, a vinylester resin, a silicone resin and so forth. As one example of that, the epoxy resin and its constituting composition will be explained below, but the present invention is not limited thereto.

### <Hydrogenated Epoxy Resin>

The curable resins applicable in the present invention include a hydrogenated epoxy resin, and an epoxy resin obtained via hydrogenation of an aromatic epoxy resin is preferably used. Examples thereof include a hydrogenated epoxy resin obtained via hydrogenation of the aromatic ring of a bisphenol A type epoxy resin, a bisphenol F type epoxy resin, a biphenol epoxy resin such as 3,3′,5,5′-tetramethyl-4,4′-biphenol type epoxy resin or 4,4′-biphenol type epoxy resin, a phenol novolac type epoxy resin, an cresol novolac type epoxy resin, a bisphenol A novolac type epoxy resin, a naphthalene diol type epoxy resin, a trisphenylolmethane type epoxy resin, a tetrakisphenylolethane type epoxy resin, and a phenol dicyclopentadiene novolac type epoxy resin. Among these, a hydrogenated epoxy resin obtained via hydrogenation of the aromatic ring of a bisphenol A type epoxy resin, a bisphenol F type epoxy resin or a biphenol epoxy resin is especially preferred in obtaining a hydrogenated epoxy resin with a high hydrogenation rate.

An alicyclic epoxy resin obtained via epoxidation of alicyclic olefin can be added in an amount of 5-50 by weight in the hydrogenated epoxy resin. As the alicyclic epoxy resin is specifically preferred 3,4-epoxycyclohexylmethyl-3′,4′-epoxycyclohexane carboxylate. An epoxy resin composition containing this alicyclic epoxy resin can reduce its viscosity, which results in improvement of the processability.

### <Acid Anhydride Curing Agent>

An acid anhydride curing agent in the epoxy resin composition applicable in the present invention is preferably an acid anhydride curing agent having no carbon-carbon double bond in the molecule. Typical examples thereof include hexahydrophthalic anhydride, methylhexahydrophthalic anhydride, hydrogenated nadic anhydride, hydrogenated methyl nadic anhydride, hydrogenated trialkyl hexahydrophthalic anhydride, and 2,4-diethylglutaric anhydride. Among these, hexahydrophthalic anhydride and/or methylhexahydrophthalic anhydride are especially preferred in providing excellent heat resistance and colorless cured materials.

The addition amount of the acid anhydride curing agent, depending on the epoxy equivalent in the epoxy resin, is preferably 40-200 parts by weight based on 100 parts by weight of epoxy resin.

### <Curing Accelerating Agent>

A curing accelerating agent can be added into the epoxy resin composition applicable in the present invention in order to promote curing reaction of the epoxy resin and the acid anhydride curing agent. Examples of the curing accelerating agent include tertiary amines and their salts, imidazoles and their salts, organic phosphine compounds, and organometallic salts such as zinc octylate and tin octylate. As the curing accelerating agent are especially preferred organic phosphine compounds. The addition amount of the curing accelerating agent is preferably in the range of 0.01-100 parts by weight based on 100 parts by weight of hydrogenated acid anhydride curing agent. The addition amount of the curing accelerating agent falling outside the above range is undesired since balance between heat resistance and humidity resistance lowers.

### <<Inorganic Particle>>

The inorganic particles dispersed in the above-described resin are inorganic particles made of a composite oxide in which at least two kinds of metal oxides are incorporated, and when variation in refractive index of the dispersed particles are represented by standard deviation σ, those can be used with no limitation as long as standard deviation σ is 0.03 or less.

The variation in refractive index (standard deviation σ) of the dispersed particles is determined by the following method.

That is, inorganic particles are dispersed in a resin of the present invention in low concentration to prepare an organic-inorganic composite material in such a way that each of the dispersed particles can be observed with no overlapping of the dispersed particles employing a transmission electron microscope, and then STEM observation-EDX mapping is conducted to calculate a ratio of each incorporated oxide-derived element (a metal element such as Si, Al, Ti or the like) with respect to each dispersed particle. When the refractive index of each dispersed particle is calculated from the ratio, standard deviation σ is given as a square root of dispersion σ² defined by the following Formula (4).

$${σ}^{2} = \frac{1}{N} {\sum }_{i = 1}^{N} {( Xi - \overline{X} )}^{2} \qquad Formula ( 4 )$$

In the above-described Formula (4), the number of evaluated dispersed particles N is preferably 200 or more.

Further, X̅ is a mean value of Xᵢ, and is represented by the following Formula (5).

$$\overline{X} = \frac{1}{N} {\sum }_{i = 1}^{N} {X}_{i} \qquad Formula ( 5 )$$

The smaller the value of standard deviation σ described above is, the higher transparent organic-inorganic composite material can be prepared, and a standard deviation σ of 0.02 or less is more preferable and a standard deviation σ of 0.01 or less is still more preferable.

The method of calculating refractive index of each dispersed particle from the ratio of each incorporated oxide-derived element via evaluation of STEM observation-EDX mapping is described below.

In the case of the composite oxide particle made of two kinds of oxides, for example, a molar ratio of oxide is calculated by determining a ratio of the oxide-derived element with respect to each dispersed particle. When this molar ratio is set to M₁:M₂ (M₁+M₂=1), and molecular volume and molecular refraction of oxide j (j=1, 2) are represented by Vⱼ and Rⱼ, respectively, refractive index X of this dispersed particle can be determined by the following Formula (6) via Lorentz-Lorenz equation.

$$\frac{{X}^{2} - 1}{{X}^{2} + 2} = \frac{{\sum }_{j = 1}^{2} {M}_{j} \cdot {R}_{j}}{{\sum }_{j = 1}^{2} {M}_{j} \cdot {V}_{j}} \qquad Formula ( 6 )$$

Herein, molecular volume Vⱼ=(molecular weight of oxide j)/(specific gravity of oxide j), and molecular refraction Rⱼ can be similarly determined from refractive index nⱼ of oxide j by using Lorentz-Lorenz equation {the following Formula (7)}.

$${R}_{j} = \frac{{n}_{j}^{2} - 1}{{n}_{j}^{2} + 2} \cdot {V}_{j} \qquad Formula ( 7 )$$

It is a feature that the inorganic particles have an average primary particle diameter of 1-50 nm in view of transparency of the organic-inorganic composite material. The average primary particle diameter of inorganic particles means a mean value of the diameter obtained by converting a single body (including a single body constituting an aggregate) into a sphere of the same volume, and this value can be evaluated from the transmission electron micrograph of a segment of an organic-inorganic composite material in which inorganic particles are dispersed in a resin. In the case of an average primary particle diameter of at least 1 nm, desired performance can be obtained since inorganic particles are easily dispersed in a resin. On the other hand, in the case of an average primary particle diameter of 1 nm or less, the resulting organic-inorganic composite material exhibits excellent transparency. Further, an average primary particle diameter of 1-30 nm is preferable, and an average primary particle diameter of 1-15 nm is more preferable.

Inorganic particles of the present invention are made of composite oxide in which at least two kinds of metal oxides are incorporated, and composite oxide particles in which silica and at least one kind of metal oxide other than silicon oxide are incorporated are preferably used.

As to the composite oxide particles of the present invention, metal constituting metal oxide other than silicon, for example, can be appropriately selected from the group consisting of Li, Na, Mg, Al, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi, and rare-earth metals. Of these, oxide in which silica and silica and metal oxide containing Al, Ti, Nb, Zr, Y, W, La, Gd or Ta are incorporated is more preferable for the composite oxide particles.

The composition distribution of composite oxide particles of the present invention is not specifically limited. Silica and another metal oxide may be substantially dispersed evenly, or may form a core/shell structure. However, for easy incorporation and easy surface treatment reasons, particles each having a core/shell structure in which the core made of metal oxide other than silicon oxide is covered by silica are preferably used, and preferably used is a method of obtaining core/shell particles by coating silica onto the core particle surface via reaction of a silica precursor in a dispersion of particles which are to be cores.

As the dispersion of particles which are to be cores, preferably used is a dispersion in which the particles each have a particle diameter close to that of a primary particle, and are dispersed. As such the dispersion, a commercially available inorganic particle dispersion is usable, and it is also possible to prepare a dispersion by dispersing powder of the commercially available inorganic particles in a dispersing medium. In this case, various homogenizers are usable for the dispersion, and a beads mill is specifically preferable. Utilized beads each having a diameter of 0.1 mm or less are preferably used As the dispersing medium, ethanol, water, a mixed solution thereof or the like is preferably used, and as a pH adjusting agent, ammonia or the like is preferably added.

A primary particle diameter mean value of particles which are to be cores is preferably 30 nm or less, more preferably 20 nm or less, and still more preferably 10 nm or less in view of transparency of the organic-inorganic composite material.

Applicable examples of the silica precursor to coat silica include tetramethoxy silane, tetraethoxy silane, polysilazane, tetramethoxy titanium, tetraethoxy titanium, tetramethoxy tungsten, tetraethoxy tungsten and so forth. Of these inorganic oxide precursors, specifically, tetramethoxy silane or tetraethoxy silane is preferably used for the reason that when forming inorganic oxide on the surface an inorganic particle which is to be a core in the inorganic oxide precursor, an aggregate of inorganic particle-to-inorganic particle is difficult to be produced, a dense layer can be formed on the surface of the inorganic particle, and a silane coupling agent is highly effective.

When preparing a dispersion of particles which are to be cores by dispersing powder of inorganic particles in a dispersing medium, it is possible to prepare a stable dispersion by conducting dispersion while appropriately adding the foregoing silica precursor during the dispersion. The above-described silica precursor is dropped while stirring the dispersion prepared in such the way to form a silica layer on the core particle surface. In this case, a silica layer is formed evenly on each dispersed particle. The silica precursor is diluted with ethanol or the like, then preferably added little by little, and preferably added continuously or intermittently spending 1-24 hours. It is also preferable to appropriately adjust the particle concentration in the dispersion, reaction temperature and pH.

It becomes possible to prepare an organic-inorganic composite material exhibiting small variation in refractive index of the dispersed particle by evenly forming the silica layer in the dispersion of particles as cores, having a particle diameter close to that of a primary particle as described above.

As to a composite oxide particle, a content ratio of silica to metal oxide other than silica can be optionally determined by the kind of metal oxide and the refractive index value of inorganic particle, but in order to have an optical organic-inorganic composite material of the present invention exhibiting high transparency, it is preferred to exhibit a small refractive index difference in comparison to a resin. Thus, nₚ and nₘ preferably satisfy the following Formulae (2) and (3), provided that the inorganic particles have an average refractive index of nₚ, and the resin before dispersing the inorganic particles has a refractive index of nₘ.

1.5≦nₚ≦1.7 Formula (2)

|nₚ−nₘ|≦0.05. Formula (3)

Average refractive index nₚ of inorganic particles can be measured by an immersion method employing reference refractive index liquid with a known refractive index with respect to light having a wavelength of 588 nm.

Further, in order to have an optical organic-inorganic composite material of the present invention exhibiting high transparency, a dispersed particle diameter of the inorganic particle in a resin is preferably small.

Examples of the method of determining a particle diameter distribution of the dispersed particle include a determination method by which image analysis is conducted with a transmission electron microscope after preparing a segment of an organic-inorganic composite material in which dispersed particles are dispersed in a resin, a determination method utilizing light scattering, a determination method with X-ray small angle scattering method and so forth, but in the case of high volume concentration of inorganic particles in a resin, a particle diameter distribution in a resin is preferably determined employing a three-dimensional transmission electron microscope (3D-TEM), and the mean value of the dispersed particle diameter obtained by that is preferably 30 nm or less. Further, the mean value of this dispersed particle diameter is preferably 20 nm or less, and more preferably 15 nm or less. Since particles having a large dispersed particle diameter degrades transparency, the number of particles having a dispersed particle diameter of at least 30 nm is further preferably 5% or less of the total number of dispersed particles.

The method of determining a particle diameter distribution of dispersed particles is, specifically, a method by which continuous inclination TEM images are acquired by continuously tilting a segment of an organic-inorganic composite material to obtain a particle diameter distribution of dispersed particles from reproduced images obtained via image processing of those images. The dispersed particle diameter mentioned here means a diameter obtained via conversion into a sphere of the same volume (sphere conversion particle diameter), and the mean value of the dispersed particle diameter is a number mean value.

Inorganic particles applicable in the present invention are preferably subjected to a surface treatment. As the method of surface-treating inorganic particles, provided can be a surface treatment employing a surface modifier such as a coupling agent or the like, and examples thereof include a wet process by which inorganic particles are subjected to a treatment in a solution in which a surface modifier is dissolved, a dry process by which powder of inorganic particles is stirred by a high-speed homogenizer such as a HENSCHEL mixer, V-type mixer or the like to be reacted by dropping a surface modifier solution therein, and so forth.

Examples of the surface modifier used for the surface treatment of inorganic particles include a silane type coupling agent, a silicone oil type coupling agent, a titanate type coupling agent, an aluminate type coupling agent, a zirconate type coupling agent and so forth. These are not specifically limited, however, can be appropriately selected depending on kinds of resins and inorganic particles.

Examples of the above-described silane type coupling agent include vinylsilazane trimethylchlorosilane, dimethyldichlorosilane, methyltrichlorosilane, trimethylalkoxysilane, dimethyldialkoxysilane, methyltrialkoxysilane, hexamethyldisilazane and so forth, and hexamethyldisilazane is suitably utilized because it can broadly cover the surface of each particle.

Usable examples of the above-described silicone oil type coupling agent include straight silicone oil such as dimethyl silicone oil, methylphenyl silicone oil or methylhydrogen silicone oil; and modified silicone oil such as amino modified silicone oil, epoxy modified silicone oil, carboxyl modified silicone oil, carbinol modified silicone oil, methacryl modified silicone oil, mercapto modified silicone oil, phenol modified silicone oil, one terminal reactive modified silicone oil, different functional group modified silicone oil, polyether modified silicone oil, methylstyryl modified silicone oil, alkyl modified silicone oil, higher fatty acid ester modified silicone oil, hydrophilic specific modified silicone oil, higher alkoxy modified silicone oil, modified silicone oil containing a higher fatty acid, fluorine modified silicone oil and so forth.

These surface treating agents may be used via appropriate dilution with hexane, toluene, methanol, ethanol, acetone, water or the like.

These surface modifiers may be used singly or in combination with plural kinds.

Since characteristics of surface-modified particles may differ depending on kinds of usable surface modifiers, the surface modifier, when an optical organic-inorganic composite material is prepared, can be selected to improve the affinity to a thermoplastic resin to be utilized. The ratio of the surface modifier is not specifically limited, but is preferably 10-99% by weight, and more preferably 30-98% by weight, based on the weight of inorganic particles having been subjected to surface modification.

### <<Additives>>

Various kinds of additives (referred to also as compounding agent) can be added, if desired, during preparation process of the optical organic-inorganic composite material of the present invention or during molding process of the organic-inorganic composite material. Examples of the additives include a plasticizer; an anti-oxidant; a light proofing stabilizer; a stabilizing agent such as a thermal stabilizer, a weather proofing stabilizer, a UV absorbent or a near-infrared absorbent; a resin improving agent such as a lubricant; a turbid preventing agent such as a soft polymer or an alcoholic compound; a colorant such as a dye or a pigment; an anti-static agent; a flame retardant; and a filler, though the additives are not specifically limited thereto. These compounding agents may be employed singly or in combination. The adding amount of the additive is suitably determined within the range in which the effects of the present invention are not jeopardized. It is preferred that the polymer contains at least a plasticizer or an antioxidant.

### [Plasticizer]

Though the plasticizer applicable in the present invention is not specifically limited, examples thereof include a phosphate based plasticizer, a phthalate based plasticizer, a trimellitate based plasticizer, a pyromellitate based plasticizer, a glycolate based plasticizer, a citrate based plasticizer, a polyester based plasticizer and so forth.

Examples of the phosphate based plasticizer include triphenyl phosphate, tricresyl phosphate, cresyl diphenyl phosphate, octyl diphenyl phosphate, diphenyl biphenyl phosphate, trioctyl phosphate, tributyl phosphate and so forth; examples of the phthalate based plasticizer include diethyl phthalate, dimethoxyethyl phthalate, dimethyl phthalate, dioctyl phthalate, dibutyl phthalate, di-2-ethylhexyl phthalate, butyl benzyl phthalate, diphenyl phthalate, dicyclohexyl phthalate and so forth; examples of the trimellitate based plasticizer include tributyl trimellitate, triphenyl trimellitate, triethyl trimellitate and so forth; examples of pyromellitate based plasticizer include tetrabutyl pyromellitate, tetraphenyl pyromellitate, tetraethyl pyromellitate and so forth; examples of glycolate based plasticizer include triacetine, tributyline, ethyl phthalyl ethyl glycolate, methyl phthalyl ethyl glycolate, butyl phthalyl butyl glycolate and so forth; and examples of the citrate based plasticizer include triethyl citrate, tri-n-butyl citrate, triethyl acetylcitrate, tri-n-butyl acetylcitrate, tri-n-(2-ethylhexyl) acetylcitrate and so forth.

### [Antioxidant]

As the antioxidant applicable in the present invention, a phenol based antioxidant, a phosphorus based antioxidant, a sulfur based antioxidant and so forth are usable and the phenol based antioxidant, particularly an alkyl-substituted phenol based antioxidant, is preferred. Addition of such antioxidants into a lens can prevent coloring and strength lowering of the lens caused by oxidation degradation, which occurs on lens molding, without lowering the transparency and the heat resistance.

These antioxidants may be employed singly or in combination with at least two kinds thereof. Though the addition amount of the antioxidant may be optionally determined within the range in which the effects of the present invention are not jeopardized, the amount is preferably 0.001-10 parts by weight, and more preferably 0.01-1 part by weight, based on 100 parts by weight of the resin.

Commonly known phenol based antioxidants can be employed as the phenol based antioxidant. Examples of the phenol based antioxidant include acrylate based compounds described in Japanese Patent O.P.I. Publication No. 63-179953 and Japanese Patent O.P.I. Publication No. 1-168643 such as 2-t-butyl-6-(3-t-butyl-2-hydroxy-5-methylbenzyl)-4-methylphenyl acrylate, 2,4-di-t-amyl-6-(1-(3,5-di-t-amyl-2-hydroxyphenyl)ethyl)phenyl acrylate and so forth; alkyl-substituted phenol based compounds such as octadecyl-3-(3,5-di-t-butyl-4-hydroxyphenyl propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl propionate)methane namely pentaerythrimethyl-tetrakis(3-(3,5-di-t-butyl-4-hydroxyphenyl propionate)), triethylene glycol-bis(3-(3-t-butyl-4-hydroxy-5-methylphenyl)propionate and so forth; and triazine group-containing phenol based compounds such as 6-(4-hydroxy-3,5-di-t-butylanilino)-2,4-bisoctylthio-1,3,5-triazine, 4-bisoctylthio-1,3,5-triazine, 2-octylthio-4,6-bis(3,5-di-t-butyl-4-oxyanilino)-1,3,5-triazine and so forth.

Examples of the phosphorus based antioxidant include monophosphite based compounds such as triphenyl phosphite, diphenyl isodecyl phosphite, phenyl diisodecyl phosphite, tris(nonylphenyl)phosphite, tris(dinonylphenyl)phosphite, tris(2,4-di-t-butylphenyl)phosphite, 10-(3,5-di-t-butyl-4-hydroxybenzyl)-9,10-dihydro-9-oxa-10-phosphaphenathlene-10-oxide and so forth; and diphosphite based compounds such as 4,4′-butylidene-bis(3-methyl-6-t-butylphenyl-di-tridecyl phosphite), 4,4′-isopropylidene-bis{phenyl-di-alkyl (C12-C15) phosphite}. Among them, the monophosphite based compound is preferable, and tris(nonylphenyl) phosphite, tris(dinonylphenyl) phosphite and tris(2,4-di-t-butylphenyl) phosphite are specifically preferred.

Examples of the sulfur based antioxidant include dilauryl 3,3-thiodipropionate, dimyristyl 3,3-thiodipropionate, distearyl 3,3-thiodipropionate, lauryl stearyl 3,3-thiodipropionate, penterythritol-tetrakis(β-lauryl-thiopropionate), 3,9-bis(2-dodecylthioethyl)-2,4,8,10-tetraoxaspiro[5,5]undecane and so forth.

### [Light Proofing Stabilizer]

As a light proofing stabilizer, a benzophenone light proofing stabilizer, a benzotriazole based light proofing stabilizer and a hindered amine based light proofing stabilizer are cited. In the present invention, the hindered amine based light proofing stabilizers are preferably employed from the viewpoint of transparency and anti-coloring property of a lens. Among the hindered amine based light proofing stabilizer (hereinafter, referred to also as HALS), ones having a molecular weight Mn in terms of polystyrene of preferably 1,000-10,000, more preferably 2,000-5,000, and still more preferably 2,800-3,800 are preferred. HALS having too small Mn has problems in that when HALS is added into a block-copolymer via heat-melting and kneading, it is difficult to add into the block-copolymer in an intended amount because of vaporization, or in that the processing suitability is lowered since bubbles and silver streaks are produced when a block-copolymer added with HALS is heat-melted and molded.

Further, when a lens is used for a long duration while a lamp is on, the volatile component in the form of gas is generated from the lens. HALS having too large Mn exhibits low dispersibility with respect to a block copolymer, so that transparency of the lens is decreased and the effect of improving a light proofing property is lowered. Accordingly, a HALS having the Mn falling within the above range provides a lens having excellent processing stability, low gas generation and high transparency.

Examples of the HALS include a high molecular weight HALS in which plural piperidine rings are combined through triazine moieties such as N,N′,N″,N′″-tetrakis-[4,6-bis-{butyl-(N-methyl-2,2,6,6-tetramethylpiperidine-4-yl)amino}-triazine-2-yl]-4,7-diazadecane-1,10-diamine, a polycondensation product of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-di-yl}{(2,2,6,6-tetramethyl-4-piperidyl)imino}hexamethylene-{(2,2,6,6-tetramethyl-4-piperidyl)imino}], a polycondensation product of 1,6-hexanediamine-N,N′-bis(2,2,6,6-tetramethyl-4-piperidyl) and morpholine-2,4,6-trichloro-1,3,5-triazine, or poly[(6-morpholino-s-triazine-2,4-di-yl)(2,2,6,6-tetramethyl-4-piperidyl)imino]-hexamethylene-[(2,2,6,6-tetramethyl-4-piperidyl)imino]; a high molecular weight HALS in which plural piperidine rings are combined through an ester bond such as a polymeric compound of dimethyl succinate and 4-hydroxy(2,2,6,6-tetramethyl-1-piperidineethanol or a mixed ester of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane; and so forth.

Among them, preferable are ones having an Mn of 2,000-5,000 such as a polycondensation product of dibutylamine, 1,3,5-triazine and N,N′-bis(2,2,6,6-tetramethyl-4-piperidyl)butylamine, poly[{(1,1,3,3-tetrabutylmethyl)amino-1,3,5-triazine-2,4-diylyl}{(2,2,6,6-tetramethyl-4-piperidyl)imino}-hexamethylene{(2,2,6,6-tetramethyl-4-piperidyl)imino}] and a polymeric compound of dimethyl succinate and 4-hydroxy-2,2,6,6-tetramethyl-1-piperidineethanol.

### [Addition Amount of Each Additives]

The addition amount of additives described above to the optical organic-inorganic composite material in the present invention, though depending on the kind, is preferably 0.01-20 parts by weight, more preferably 0.02-15 parts by weight, and still more preferably 0.05-10 parts by weight, based on 100 parts by weight of polymer. In the case of too small addition amount, the effect of improving a light proofing property is insufficiently produced, so that when it is used in an optical element such as a lens, coloring is caused via laser exposure. On the other hand, in the case of too large addition amount, a part of the additive volatiles as gas or the additive dispersion property in the resin is lowered, resulting in lowering of transparency of the lens.

Further, a compound having the lowest glass transition point of not more than 30° C. is preferably added into the organic-inorganic composite material. By this, the foregoing can prevent occurrence of white turbid without lowering properties such as transparency, heat resistance and mechanical strength for a long duration at high temperature and high humidity.

### <<Method of Manufacturing Optical Organic-Inorganic Composite Material>>

The optical organic-inorganic composite material of the present invention comprises the resin and inorganic particles as described above, but a manufacturing method thereof is not specifically limited.

In cases where a thermoplastic resin is used as a resin, there is mentioned any of incorporation methods such as an incorporation method by polymerizing a thermoplastic resin in the presence of inorganic particles, an incorporation method by forming inorganic particles in the presence of the thermoplastic resin, an incorporation method by dispersing inorganic particles in a solvent for a thermoplastic resin to prepare a dispersion and removing the solvent from the dispersion, and an incorporation method by melt-kneading or melt-kneading in the presence of solvent after separately providing inorganic particles and a thermoplastic resin. Further, each additive can be added at any stage during the incorporation process, but the adding timing, which exhibits no adverse effect on the manufacture, can be selected.

Among these, a method in which inorganic particles and a thermoplastic resin are individually provided and then mixed during melt-kneading is preferred since it is easy and reduces manufacturing cost. As devices usable in melt-kneading, there are mentioned a sealing type melt-kneading device such as Laboplasto Mill, a brabender, a banbury mixer, a kneader or a roll; and a batch type melt-kneading device. Also, sequential melt-kneading devices such as a single screw extruder and a twin screw extruder can be used for preparation.

In the method of manufacturing the optical organic-inorganic composite material of the present invention, the thermoplastic resin and the inorganic particles may be mixed all together and kneaded, or may be kneaded via stepwise split addition. In the latter case, in the melt-kneading devices such as the extruders, a component to be added stepwise can be added at a middle of the cylinder. Further, after having kneaded in advance, a component not added in advance except for thermoplastic resin is mixed and melt-kneaded, they can be mixed all together or can be kneaded via stepwise split addition. The method of split addition may be a method where one component is mixed in several installments, a method where a component is mixed at once and then different components are added stepwise, or a method in combination with any of methods thereof.

In the case of the preparation via a melt-kneading method, the inorganic particles can be added as in the form of powder or aggregates. Alternatively, they can be added as in the form of dispersion dispersed in liquid, and when added as in the form of dispersion dispersed in liquid, degassing is preferably carried out after kneading.

As to an optical organic-inorganic composite material of the present invention, when a curable resin is employed as a resin, the optical organic-inorganic composite material can be obtained by mixing a monomer for the curable resin, a curing agent, a curing accelerating agent and various additives with inorganic particles having been subjected to an appropriate surface treatment; and curing the resulting mixture via exposure to UV radiation or electron beam exposure, or via thermal treatment.

As to the optical organic-inorganic composite material of the present invention, the content of inorganic particles in the optical organic-inorganic composite material is not specifically limited as long as it falls within the range to produce the effect of the present invention, and can be arbitrarily determined, depending on kinds of resins and inorganic particles.

However, in the case of a small content of inorganic particles, inorganic particles in the optical organic-inorganic composite material preferably have a volume fraction Φ of at least 0.2, and more preferably have a volume fraction Φ of at least 0.3, since the effect of improving temperature dependence of an intended optical property in the present invention is possible to be reduced.

On the other hand, in the case of a large content of inorganic particles, inorganic particles in the optical organic-inorganic composite material preferably have a volume fraction Φ of 0.6 or less, and more preferably have a volume fraction Φ of 0.5 or less, since there possibly appear problems such that inorganic particles are difficult to be added into a resin, kneading and mounting are difficult to be conducted because of the optical organic-inorganic composite material which becomes hard, and specific gravity of the optical organic-inorganic composite material becomes large.

In addition, volume fraction Φ of inorganic particles in the optical organic-inorganic composite material is calculated by the following expression.

Φ=the total volume of inorganic particles in an optical organic-inorganic composite material/the volume of the optical organic-inorganic composite material

The mixing degree of a resin and inorganic particles in the organic-inorganic composite material is not specifically limited, but evenly mixing is preferred in order to produce the advantageous effect of the present invention efficiently. Insufficient degree of mixing produces a problem such that the particle diameter distribution of the inorganic particles in the organic-inorganic composite material is difficult to satisfy the condition specified by the present invention. Since the particle diameter distribution of inorganic particles in a thermoplastic resin composition resin depends largely on a manufacturing method thereof, an optimum manufacturing method should be selected via sufficient consideration of properties of the thermoplastic resin composition resin and inorganic particles to be employed.

Various molding products can be obtained by molding the organic-inorganic composite material as described above, but the molding method is not specifically limited. When a thermoplastic resin is used as a resin, a melt-molding method is preferably utilized to obtain a molding product exhibiting excellent properties such as low birefringence, mechanical strength, dimensional stability and so forth. Examples of the melt molding methods include commercially available press molding, commercially available extrusion molding, commercially available injection molding and so forth. Among these, the injection molding is preferable in view of a molding property and productivity.

On the other hand, when a curable resin is employed as a resin, a mixture of a resin composition such as a monomer of the curable resin, a hardener or the like with inorganic particles is subjected to ultraviolet or electron beam exposure for curing or to thermal treatment, and when the curable resin is an ultraviolet curable or electron beam curable resin, the resin composition after incorporated in a light transmitting mold or coated on an appropriate substrate is subjected to ultraviolet or electron beam exposure for curing. When a resin is a heat curable resin, curing and molding can be carried out through compression molding, transfer molding or injection molding.

### <<Applied Field>>

The molding product of the optical organic-inorganic composite material as described above is applicable to an optical element. The molding product can be utilized in various forms such as a spherical form, a bar form, a plate form, a column form, a cylinder form, a tube form, a fiber form, or a film or sheet form, and is applicable to various optical elements since it is excellent in low birefringence, transparency, mechanical strength, heat resistance and low water absorption.

For example, the molding products are applicable to optical lenses and optical prisms including an image pick lens of a camera; a lens of a microscope, an endoscope and a telescope; an all-optical transmitting lens such as eyeglass lens; a pickup lens for an optical disk such as CD, CD-ROM, WORM (recordable optical disk), MO (rewritable optical disk; magnetooptical disk), MD (mini-disk) or DVD (digital video disk); and a lens in a laser scanning system such as an fθ lens for a laser beam printer and a lens for a sensor; and a prism lens in a finder system of a camera.

Examples of other optical applications include a light guide plate such as a liquid crystal display or the like; an optical film such as a polarizer film, a retardation film or an optical diffusion film; an optical diffusion plate; an optical card; a liquid crystal display element substrate; and so forth.

Among the molding products described above, they are preferably used as an optical element such as a pickup lens or a laser scanning system lens, which exhibits low birefringence.

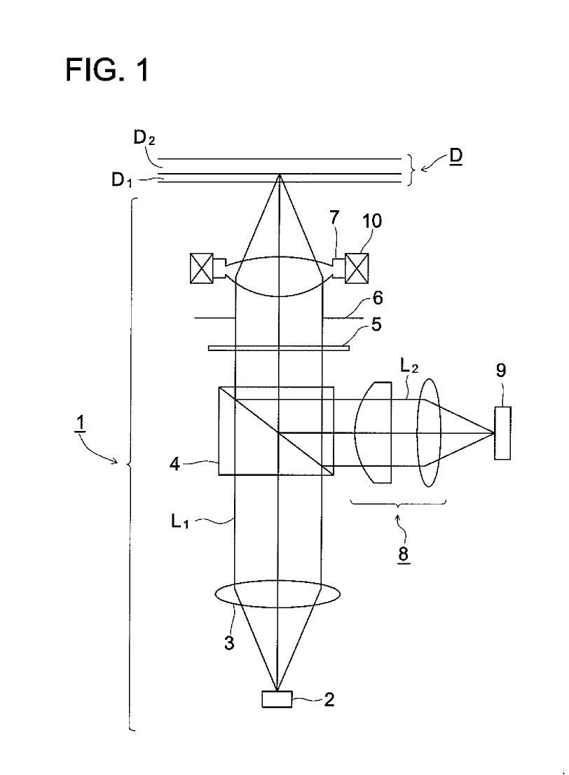

Next, optical pickup apparatus 1 fitted with an optical element molded from the optical organic-inorganic composite material of the present invention will be described referring to FIG. 1.

FIG. 1 is a diagram showing the inner structure of optical pickup apparatus 1.

Optical pickup apparatus 1 in the present embodiment is equipped with semiconductor laser oscillator 2 as a light source as shown in FIG. 1. Collimator 3, beam splitter 4, ¼ wavelength plate 5, aperture 6, and objective lens 7 are provided in that order in the direction distant from semiconductor laser oscillator 2 along the optical axis of blue light ejected from semiconductor laser oscillator 2.

Sensor lens group 8 composed of two sets of lens and sensor 9, each being adjacent to beam splitter 4, are provided in that order in the direction perpendicular to the optical axis of blue light.

Objective lens 7 as an optical element is provided so as to face optical disk D and to converge the blue light emitted from semiconductor laser oscillator 2 on one surface of optical disk D. Objective lens 7 is fitted with two-dimensional actuator 10, and objective lens 7 is freely moved on the optical axis via action of two-dimensional actuator 10.

Next, operation of optical pickup apparatus 1 will be described.

Optical pickup apparatus 1 in the present embodiment emits blue light from semiconductor laser oscillator 2 during recording action of information into optical disk D, and during reproducing action of information recorded into optical disk D. As shown in FIG. 1, the emitted blue light which has become light L1 passes through collimator 3, collimated into infinite parallel light, then passes through beam splitter 4 and ¼ wavelength plate 5. Further, after passing through aperture 6 and objective lens 7 to form a converged spot on information recording plane D₂ via protective substrate D₁ of optical disk D.

The light having formed the converged spot is modulated by information pits of information recording plane D₂ of optical disk D and reflected by the information recording plane D₂. The resulting reflected light passes through objective lens 7 and aperture 6 in that order, and after the polarizing direction being changed by ¼ wavelength plate 9, the light is reflected on beam splitter 4. Further, the resulting light passes through sensor lens group 8, is provided with astigmatism, and received on sensor 9. Finally, the light is subjected to photoelectric conversion with sensor 9 to be an electric signal.

After this, such the phenomenon is repeated, whereby recording of information to optical disk D and reproduction of information recorded on optical disk D are performed.

In addition, numerical aperture NA desired for objective lens 7 differs depending on size of information bits or thickness of protective substrate D₁ of optical disk D. In the present embodiment, the optical disk has high density, and the numerical aperture is set to 0.85.

### EXAMPLE

Next, the present invention will now be specifically described referring to examples, but the present invention is not limited thereto. Incidentally, “parts” and “%” represent parts by weight and by weight, respectively, unless otherwise specifically specified.

### Example 1

### Preparation of Inorganic Particles

### (Preparation of Inorganic Particle A)

Inorganic particle A was prepared in accordance with each process described below.

### <Dispersion Process>

A solution in which 50 ml of pure water, 390 ml of special grade ethanol produced by Kanto Kagaku Co. Ltd., and 22 ml of 28% ammonia produced by Kanto Kagaku Co. Ltd. were added to alumina (alumina C having a primary particle diameter of 13 nm, produced by Nippon Aerosil Co., Ltd.), and 0.72 g of tetraethoxysilane (LS-2430, produced by Shin-Etsu Kagaku Co., Ltd.) were added into the foregoing solution. The resulting solution was dispersed with 0.05 mm beads employing an Ultra Apex Mill (produced by Kotobuki Co., Ltd.) at a peripheral speed of 6 m/sec for one hour. After this, 2 g of tetraethoxysilane (LS-2430, produced by Shin-Etsu Kagaku Co., Ltd.) were further added into the dispersion, followed by stirring for one hour in the same manner as described above.

Subsequently, 18.16 g of tetraethoxysilane (LS-2430, produced by Shin-Etsu Kagaku Co., Ltd.) was diluted with a solution in which 40 ml of ethanol were mixed with 5 ml of pure water, and the diluted solution was dropped in the dispersion obtained in the above-described dispersion process spending 10 minutes. The resulting solution was stirred at room temperature for 20 hours to form a silica layer on the surface of alumina.

### <Hydrophobization Treatment Process>

Then, inorganic particles were separated from the above-described solution employing a centrifuge separator, followed by drying at reduced pressure at 80° C. for 24 hours. The dried inorganic particles were charged in a 300 ml egg plant flask, and pressure thereof was reduced to 1.3 kPa or less, followed by heating at 190° C. for one hour. After this, the inside of the egg plant flask was replaced by argon, and 10% by weight of hexamethylsilazane (HMDS-3, produced by Shin-Etsu Kagaku Co., Ltd.) based on inorganic particles were added, followed by stirring at 300° C. for 2 hours.

White powder obtained via each process described above was designated as inorganic particle A. Measured inorganic particle A had an average primary particle diameter of 18 nm.

### (Preparation of Inorganic Particle B)

Inorganic particle B was prepared similarly to preparation of inorganic particle A, except that a diluted solution of tetraethoxysilane was dropped in the dispersion spending one hour in the layer formation process for preparation of the above-described inorganic particle A. Measured inorganic particle B had an average primary particle diameter of 18 nm.

### (Preparation of Inorganic Particle C)

Inorganic particle C was prepared similarly to preparation of inorganic particle A, except that a diluted solution of tetraethoxysilane was dropped in the dispersion spending 5 hours in the layer formation process for preparation of the above-described inorganic particle A. Measured inorganic particle C had an average primary particle diameter of 18 nm.

### (Preparation of Inorganic Particle D)

An aqueous solution of sodium metasilicate (Na₂SiO₃) was neutralized and condensed with a hydrochloric acid to obtain an aqueous silicic acid solution. This aqueous silicic acid solution was solvent-extracted with tetrahydrofuran (THF) to obtain a THF solution of 0.85 mol/L of silicic acid as SiO₂. Then, 5% by weight of a methanol solution based on titanium tetrachloride were added in such a way that a molar ratio of Ti/Si was 0.1 to obtain a dispersion of silica/titania composite particles via reaction with solvent reflux flow for 2 hours.

Then, inorganic particles were separated from the above-described solution employing a centrifuge separator, followed by drying at reduced pressure at 80° C. for 24 hours.

Next, as to the resulting particles, a hydrophobization treatment was conducted by the same process as the hydrophobization treatment process for preparation of the above-described inorganic particle A. The resulting white powder was designated as inorganic particle A. Measured inorganic particle D had an average primary particle diameter of 18 nm.

### (Preparation of Inorganic Particle E)

Ten grams of alumina/silica composite particles having a weight ratio of Al₂O₃/SiO₂ of 44/56 and an average primary particle diameter of 79 nm (produced by Hosokawa Micron Corp.) were charged in a 300 ml egg plant flask, and pressure thereof was reduced to 1.3 kPa or less, followed by heating at 190° C. for one hour. After this, the inside of the egg plant flask was replaced by argon, and 3% by weight of hexamethylsilazane (HMDS-3, produced by Shin-Etsu Kagaku Co., Ltd.) based on inorganic particles were added, followed by stirring at 300° C. for 2 hours to obtain inorganic particle E having subjected to a surface treatment.

### (Preparation of Inorganic Particle F)

Ten grams of magnesium oxide/silica composite particles having a weight ratio of MgO/SiO₂ of 26/74 and an average primary particle diameter of 40 nm (produced by Hosokawa Micron Corp.) were charged in a 300 ml egg plant flask, and pressure thereof was reduced to 1.3 kPa or less, followed by heating at 190° C. for one hour. After this, the inside of the egg plant flask was replaced by argon, and 5% by weight of hexamethylsilazane (HMDS-3, produced by Shin-Etsu Kagaku Co., Ltd.) based on inorganic particles were added, followed by stirring at 300° C. for 2 hours to obtain inorganic particle F having subjected to a surface treatment.

### Preparation of Sample

### (Preparation of Sample 1)

A cycloolefin resin was employed as a thermoplastic resin (APEL5014, produced by Mitsui Chemicals Inc.), and inorganic particle A was employed as inorganic particles. Inorganic particle A was melt-kneaded with the above-described thermoplastic resin to prepare Sample 1 as an optical organic-inorganic composite material. Specifically, Labo Plastomill (Labo Plastomill KF-6V, manufactured by Toyo Seiki Seisaku-Sho, Ltd.) was employed as a kneading machine to knead the above-described thermoplastic resin and inorganic particle A at 100 rpm for ten minutes under nitrogen atmosphere, and degassing was conducted at a reduced pressure of 2.6 kPa for 2 minutes before termination. In addition, as to the content of inorganic particle A, volume fraction Φ of inorganic particle A in Sample 1 was arranged to 0.3.

### (Preparation of Samples 2-6)

Samples 2-6 as the optical organic-inorganic composite material were prepared similarly to preparation of the above-described Sample 1, except that inorganic particle A was replaced by each of inorganic particles B-F.

### Evaluation of Inorganic Particle and Sample

### [Measurement of Refractive Index of Inorganic Particle]

As to commercially available refractive index liquid (cargille reference refractive index liquid, provided by MORITEX Corp.), liquid exhibiting a refractive index of 1.45-1.75 at a wavelength of 588 nm was arranged to be prepared at 0.01 intervals in refractive index. Next, each of inorganic particles A-F to be evaluated was dispersed in the above-described reference refractive index liquid, and refractive index of the refractive index liquid at a time when transmittance of each dispersion at a wavelength of 588 nm reached the highest value was designated as refractive index nₚ of each of inorganic particles A-F at a wavelength of 588 nm. Refractive index nₚ of each of inorganic particles obtained as described above is shown in Table 2.

[Measurement of Refractive Index and dn/dT Rate-of-Change of Resin and Sample]

After heat-melting a thermoplastic resin with no addition of each of inorganic particles A-F (cycloolefin resin APEL5014, produced by Mitsui Chemicals Inc.), molding was made in the form of a plate having a thickness of 3 mm. This plate was polished. The refractive index at a wavelength of 588 nm at each temperature while the thermoplastic resin plate temperature was changed from 23° C. to 60° C. was measured employing an automatic refractometer (KPR-200, manufactured by Kalnew Optical Industrial Co., Ltd.), and the temperature rate-of-change of refractive index varied by the temperature was calculated. The refractive index at a wavelength of 588 nm at 23° C. was designated as refractive index nₘ. Refractive index nₘ of the thermoplastic resin obtained as described above is shown in Table 2.

Similarly to the above-described, after heat-melting each of Samples 1-6, molding was made in the form of a plate having a thickness of 3 mm. The refractive index at a wavelength of 588 nm at each temperature while the temperature of each of Samples 1-6 was changed from 23° C. to 60° C. was measured, and the temperature rate-of-change of refractive index varied by the temperature for each of Samples 1-6 was calculated. Based on these calculated results, the dn/dT rate-of-change of each sample was calculated via the following equation, acquired results are shown in Table 2.

dn/dT rate-of-change=|(dn/dT of thermoplastic resin−dn/dT of each sample)/(dn/dT of thermoplastic resin)|×100(%)

### [Measurement of Refractive Index Variation (Standard Deviation σ) of Dispersed Particle of Inorganic Particle]

One obtained by crushing each of Samples 1-6 and a thermoplastic resin (APEL5014, produced by Mitsui Chemicals Inc.) employed for preparation of each of Samples 1-6 were mixed in such a way that volume fraction Φ of inorganic particles became 0.03, and melt-kneading was conducted employing Laboplasto Mill (KF-6V). Degassing was conducted at a reduced pressure of 2.6 kPa for 2 minutes before termination, molding was made in the form of a plate having a thickness of 3 mm via heat-melting.

A segment of the resulting plate was prepared to conduct STEM observation-EDX mapping. As to 200 dispersed particles selected at random for each sample, a ratio of each incorporated oxide-derived element (a metal element such as Si, Al, Ti, Mg or the like) was calculated. The refractive index of each dispersed particle is calculated from the ratio to determine standard deviation σ of each sample by the foregoing Formula (4). Results obtained here are shown in Table 2.

### [Measurement of Transmittance of Sample]

After heat-melting each of Samples 1-6, each of Samples 1-6 was molded in the form of a plate having a thickness of 3 mm. As to each of the resulting Samples 1-6 in the form of a plate, transmittance at a wavelength of 405 nm and transmittance at a wavelength of 588 nm in the thickness direction were measured employing a spectrophotometer (UV-3150, produced by Shimadzu corporation). Results obtained here are shown in Table 2.

TABLE 2

| | | | | | | | dn/dT | | | |
|---|---|---|---|---|---|---|---|---|---|---|
| | | | | | | | rate- | | | |
| | Inorganic | | Refractive index | | | | of- | | | |
| | particle | | properties | | | Standard | change | Transmittance | | |
| *1 | *2 | *3 | nₚ | nₘ | \|nₚ − nₘ\| | deviation σ | (%) | 405 nm | 588 nm | *4 |
| 1 | A | 18 | 1.54 | 1.543 | 0.003 | 0.028 | 37 | 70.1 | 85.3 | Inv |
| 2 | B | 18 | 1.54 | 1.543 | 0.003 | 0.017 | 39 | 78.6 | 88.8 | Inv |
| 3 | C | 18 | 1.54 | 1.543 | 0.003 | 0.008 | 41 | 86.2 | 90.4 | Inv |
| 4 | D | 18 | 1.54 | 1.543 | 0.003 | 0.040 | 33 | 48.9 | 79.8 | Comp |
| 5 | E | 79 | 1.53 | 1.543 | 0.013 | 0.028 | 22 | 0.3 | 28.1 | Comp |
| 6 | F | 40 | 1.53 | 1.543 | 0.013 | 0.032 | 28 | 29.0 | 72.6 | Comp |

*1: Sample No.
*2: Symbol
*3: Average primary particle diameter (nm)
*4: Remarks
Inv: Present invention,
Comp: Comparative example

As is clear from the results shown in Table 2, it is to be understood that the samples of the present invention employing inorganic particles made of a composite oxide in which at least two kinds of metal oxides are incorporated, the inorganic particles in which dispersed particles have a refractive index variation standard deviation σ of 0.03 or less, and have an average primary particle diameter of 1-50 nm, are optical organic-inorganic composite materials in which rate-of-change dn/dT is large in temperature change, the effect of compensating an amount of change dn/dT (unit: minus) of a resin becomes high, rate-of-change of refractive index with respect to temperature change of the optical organic-inorganic composite material can be suppressed to be minimized, and transmittance at a wavelength of 405 nm and transmittance at a wavelength of 588 nm are high in comparison to those of Comparative examples.

### Example 2

### Preparation of Sample

### (Preparation of Sample 7)

Charged are 100 parts by weight of a curable resin of 3,4-epoxycyclohexenylmethyl-3′,4′-epoxycyclohexene carboxylate (Celoxide 2021, produced by Daicel Kagaku Kogyo Co., Ltd.) as a resin, 100 parts by weight of methyhexahydrophthalic anhydride (Epichrone B-650, produced by DIC Corporation) as a hardener, 3 parts by weight of 2-ethyl-4-methylimidazole (2E4MZ, produced by Shikoku Kasei Kogyo Co., Ltd.) as a hardening accelerator, 0.1 parts by weight of a phenol type antioxidant of (tetrakis(methylene-3-(3′,5′-di-t-butyl-4′-hydroxyphenylpropionate)methane) as a stabilizer and 0.1 parts by weight of a phosphorus based stabilizer of (2,2′-methylenebis(4,5-di-t-butyl-phenyl)-2-ethylhexyl phosphite), and inorganic particle A is added into the resulting mixture and dispersed employing Labo Plastomill (Labo Plastomill KF-6V, manufactured by Toyo Seiki Seisaku-Sho, Ltd.). After the resulting dispersion was degassed at a reduced pressure, it was cast into a mold, and molding was conducted in an oven at 100° C. for 3 hours, and further at 140° C. for 3 hours to obtain colorless Sample 7. In this case, an addition amount of inorganic particles is adjusted in such a way that volume fraction Φ of inorganic particle A is to be Φ=0.3.

(Preparation of Samples 8-12)

Samples 8-12 were prepared similarly to preparation of the above-described Sample 7, except that inorganic particle A was replaced by each of inorganic particle B, inorganic particle C, inorganic particle D, inorganic particle E and inorganic particle F.

### <<Evaluation of Samples>

Similarly to the method described in Example 1, refractive index, dn/dT variation rate and transmittance of light of each sample were measured. In addition, each of Samples 7-12 was cut to be in the form of a plate having a thickness of 3 mm to measure the transmittance. Further, refractive index nₘ of a resin is a refractive index of a hardened material cured via no addition of inorganic particles, and the dn/dT variation rate is designated as a do/dT variation rate with respect to a hardened material cured via no addition of inorganic particles.

Further, As to the measurement of refractive index variation (standard deviation σ) of dispersed particles of inorganic particles, the hardened material was prepared in such a way that volume fraction Φ of inorganic particles for each of inorganic particle A, inorganic particle B, inorganic particle C, inorganic particle D, inorganic particle F and inorganic particle F was to be Φ=0.3, similarly to the method of preparing Samples 7-12, and this segment was measured by conducting STEM observation-EDX mapping.

Results obtained from the above-described are shown in Table 3.

TABLE 3

| | | | | | | | dn/dT | | | |
|---|---|---|---|---|---|---|---|---|---|---|
| | | | | | | | rate- | | | |
| | Inorganic | | Refractive index | | | | of- | | | |
| | particle | | properties | | | Standard | change | Transmittance | | |
| *1 | *2 | *3 | nₚ | nₘ | \|nₚ − nₘ\| | deviation σ | (%) | 405 nm | 588 nm | *4 |
| 7 | A | 18 | 1.54 | 1.525 | 0.015 | 0.028 | 36 | 71.0 | 85.5 | Inv |
| 8 | B | 18 | 1.54 | 1.525 | 0.015 | 0.017 | 37 | 81.8 | 88.2 | Inv |
| 9 | C | 18 | 1.54 | 1.525 | 0.015 | 0.008 | 43 | 87.3 | 89.5 | Inv |
| 10 | D | 18 | 1.54 | 1.525 | 0.015 | 0.040 | 33 | 56.2 | 81.3 | Comp |
| 11 | E | 79 | 1.53 | 1.525 | 0.005 | 0.028 | 23 | 1.2 | 30.6 | Comp |
| 12 | F | 40 | 1.53 | 1.525 | 0.005 | 0.032 | 29 | 34.0 | 73.7 | Comp |

*1: Sample No.
*2: Symbol
*3: Average primary particle diameter (nm)
*4: Remarks
Inv: Present invention,
Comp: Comparative example

As is clear from the results shown in Table 3, even in cases where a curable resin is employed as a resin, similarly to the results of Example 1, it is to be understood that the samples of the present invention are optical organic-inorganic composite materials in which rate-of-change dn/dT is large in temperature change, the effect of compensating an amount of change dn/dT (unit: minus) of a resin becomes high, rate-of-change of refractive index with respect to temperature change of the optical organic-inorganic composite material can be suppressed to be minimized, and transmittance at a wavelength of 405 nm and transmittance at a wavelength of 588 nm are high in comparison to those of Comparative examples.

1. An optical organic-inorganic composite material comprising inorganic particles comprising a composite oxide in which at least two kinds of metal oxides are incorporated, the inorganic particles dispersed in a resin in a state of primary particles or in a state where the plural number of primary particles are coagulated,
wherein the dispersed particles have a refractive index variation standard deviation σ of 0.03 or less, and
the inorganic particles have an average primary particle diameter of 1-50 nm.

2. The optical organic-inorganic composite material of claim 1,
wherein the inorganic particles comprise a composite oxide in which silica and at least one kind of metal oxide other than silicon oxide are incorporated.

3. The optical organic-inorganic composite material of claim 1,
wherein the inorganic particles comprise a particle having a core/shell structure in which a core made of metal oxide other than silicon oxide is covered by silica, the core/shell particle obtained by coating silica onto a surface of a core particle via reaction of a silica precursor in a dispersion comprising the core particle.

4. The optical organic-inorganic composite material of claim 1,
wherein nₚ and nₘ satisfy all of the following Formulae (1)-(3), provided that the inorganic particles have an average refractive index of nₚ, and the resin before dispersing the inorganic particles has a refractive index of nₘ:
1.5≦nₘ≦1.7 Formula (1)
1.5≦nₚ≦1.7 Formula (2)

|nₚ−nₘ|≦0.05. Formula (3)

5. An optical element comprising the optical organic-inorganic composite material of claim 1 as a mold material.
